(19) United States
(12) Patent Application Publication
(10) Pub. No.: US 2016/0039078 A1
(43) Pub. Date: Feb. 11, 2016

(54) HAMMER

(71) Applicant: Joshua D. West, Rockford, IL (US)

(72) Inventor: Joshua D. West, Rockford, IL (US)

(21) Appl. No.: 14/451,819

(22) Filed: Aug. 5, 2014

(51) Int. Cl. B25D 1/12

(52) U.S. Cl. CPC B25D 1/12

(57) ABSTRACT

Striking tools are disclosed herein that may include a skeleton including a handle portion with a first end and a second end and a head portion disposed on the second end of the handle portion, the head portion having a front portion, a top portion, and a rear portion that form first and second lateral cavities. The striking tools further include a matrix bonded to the skeleton that may extend through the skeleton.

### CROSS REFERENCE TO RELATED APPLICATIONS

Not applicable

### REFERENCE REGARDING FEDERALLY SPONSORED RESEARCH OR DEVELOPMENT

Not applicable

### SEQUENCE LISTING

Not applicable

### BACKGROUND OF THE INVENTION

1. Field of the Background

The present invention relates generally to striking tools, and more specifically, to light weight composite striking tools.

2. Description of the Background

Striking tools, like hammers, are often formed from steel which is necessitated by the forces required to repeatedly drive and remove nails, remove studs during demolition and rehab, and similar strenuous endeavors. However, such steel construction, while providing greater durability, also makes for heavier tools that more quickly fatigue a user when used for extended periods of time.

One approach to overcome the disadvantages of the heavy construction of steel hammers has been to construct the hammer, at least in part, of a lighter material, such as wood or fiberglass, which was used for the handle. More recently, other lighter weight hammer designs have included a head made of titanium or titanium alloy, with a hard striking surface or working tip attached thereto by a threaded connector, welding, brazing, adhesives, or shrink fitting (heat treatment).

Other approaches to reduce hammer weight have included using thin-walled tubular metallic handles. Similarly, replaceable handles for striking tools have been made of molded, rigid structural plastic foam reinforced with a plastic core or plastic handles reinforced with aluminum tube cores. However, these tools lack the same strength of one-piece, all steel striking tools where the head and handle are formed from a single piece of steel. For this reason, oftentimes such lighter weight tool constructions have resulted in short-lived tools unable to withstand the same forces as all-steel hammers. Moreover, many of these designs have not been able to reduce the weight of the head of the striking tool, and thus, have little effect in reducing the fatigue experienced by the user when used for extended periods.

There is a need, therefore, for light weight striking tools with durable construction that provide greater ease of use and prolonged tool life.

### SUMMARY OF THE INVENTION

According to one aspect, a striking tool includes a skeleton having a handle portion with a first end and a second end, and a head portion disposed on the second end of the handle portion and having a front portion, a top portion, and a rear portion that form first and second lateral cavities. The striking tool further includes a matrix bonded to the skeleton.

According to another aspect, a striking tool including a skeleton having a handle portion with a first end and a second end, and a head portion disposed on the second end of the handle portion and including a striking surface. The striking tool further includes a matrix bonded to the skeleton. The matrix reduces total skeletal deformation of the skeleton from a load applied to the striking surface.

According to a further aspect, a composite striking tool includes a skeleton having a handle portion with a first end and a second end, and a head portion disposed on the second end of the handle portion and including a striking surface. The striking tool further includes a matrix bonded to the skeleton. The matrix reduces torsion of the skeleton from a load applied to the striking surface.

### BRIEF DESCRIPTION OF THE DRAWINGS

Other aspects and advantages of the present invention will become apparent upon reading the following detailed description and upon reference to the drawings in which:

FIG. 1 is a front, left, top isometric view of a skeleton of a composite striking tool according to one embodiment;

FIG. 2 is a left side elevational view of the skeleton of FIG. 1;

FIG. 3 is a right side elevational view of the skeleton of FIG. 1;

FIG. 4 is a partial, left side elevational view of a composite striking tool according to one embodiment;

FIG. 5 is a front, left, top isometric view of a composite striking tool according to another embodiment;

FIG. 6 is a partial, rear cross-sectional view of the head portion of the skeleton of FIG. 3 taken generally along lines 6-6 according to one embodiment;

FIG. 7 is a partial, rear cross-sectional view of the head portion of the composite hammer of FIG. 4 taken generally along lines 7-7; and

FIG. 8 is a diagram of load application placement for load cases described in the examples.

### DETAILED DESCRIPTION OF THE INVENTION

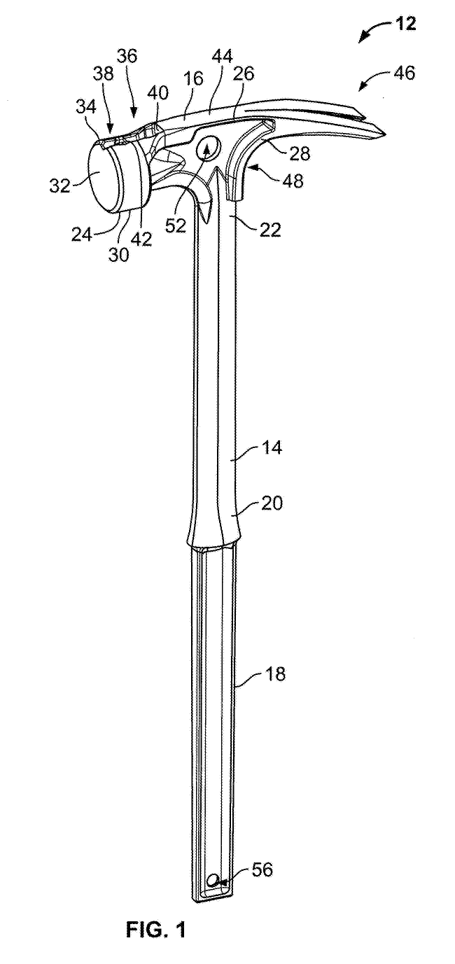

As depicted in FIGS. 1-3, 6, and 7 composite striking tools 10 of the present disclosure include a skeleton 12 that generally includes a handle portion 14 and a head portion 16. The handle portion 14 may include a first end 18, a collar 20, and a second end 22. The head portion 16 is disposed on the second end 22 of the handle portion 14 and may include a front portion 24, a top portion 26, and a rear portion 28.

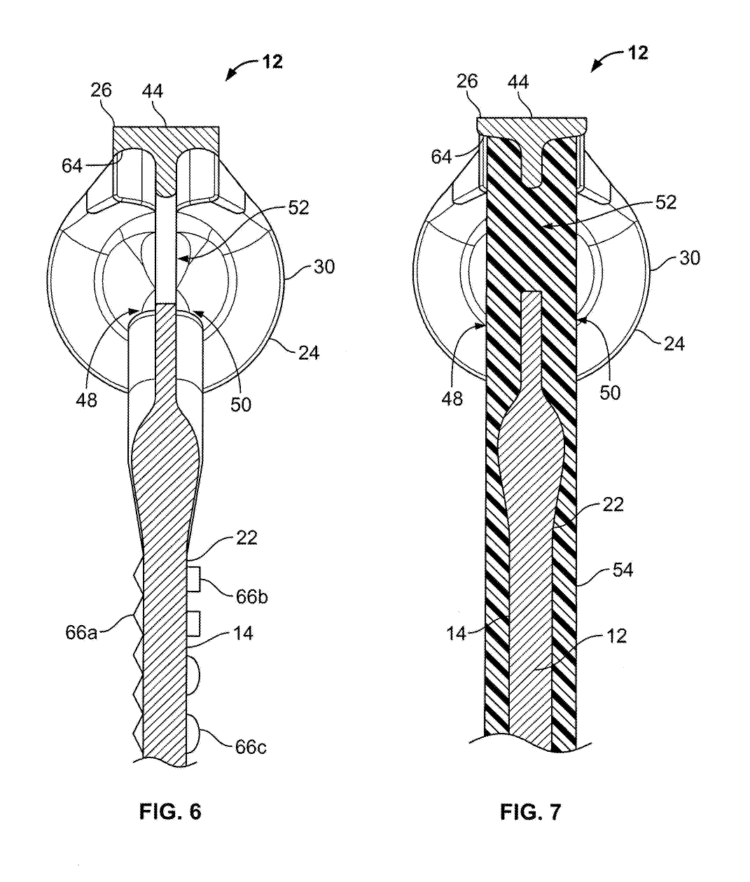

The front portion 24 of the head portion 16 may include a poll 30 and a striking surface 32, which in one embodiment may be substantially flat or slightly convex. The striking surface 32 may also be surrounded by a chamfer or bevel 34. The top portion 26 of the head portion 16 may include a magnetic nail starter 36 that includes a furrow 38 extending from the striking surface 32 to a nail head support 40. A magnet 42 is disposed within the furrow 38 to secure a nail (not shown) placed therein. The top portion 26 further includes a top surface 44 that may be substantially flat or slightly curved as it extends from the front portion 24 to the rear portion 28. The rear portion 28 may be formed to have any number of different features, such as a claw 46 as shown in the figures, or may instead include a pick, a cutting edge such as a chisel or axe blade, or another striking surface (not shown). When the rear portion 28 includes a claw 46, the top surface 44 may serve as a fulcrum when the striking tool 10 is used to pry an object with the claw. The front 24, top 26, and rear 28 portions of the head portion 16 form the front, top, and rear walls of first 48 and second 50 lateral cavities of the head portion (see FIGS. 6 and 7). The lateral cavities 48 and 50 may be fluidly connected to one another by one or more transverse apertures 52 in the head portion 16.

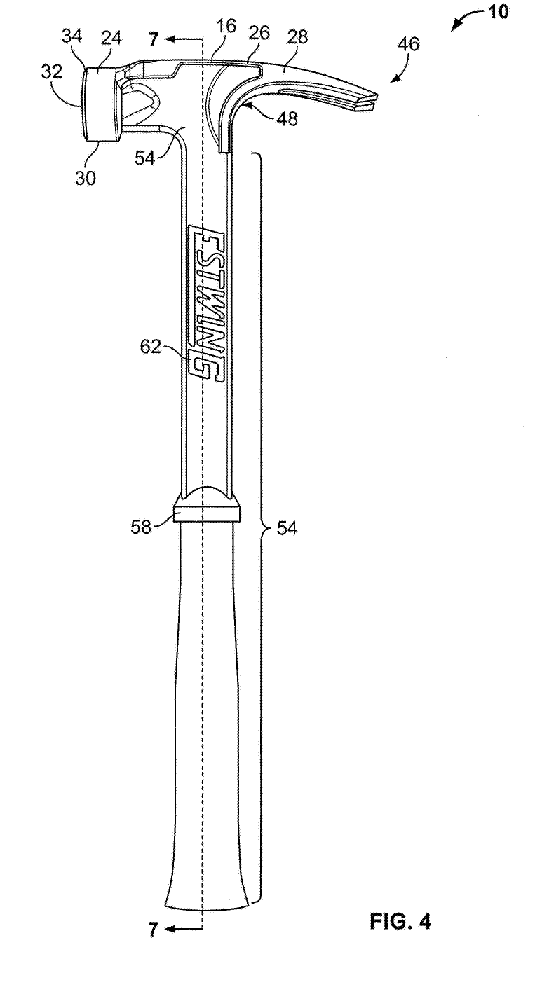

As seen in FIGS. 4, 5, and 7, the composite striking tools 10 of the present disclosure further include a matrix 54 that may be molded onto and bonded with the skeleton 12 to form the composite structure of the striking tools. In one embodiment, the matrix 54 may be injection molded directly onto the skeleton 12. In another embodiment, the matrix 54 completely envelopes the first end 18 of the handle portion 14 (as seen in FIG. 4), covers the collar 20, and extends to the second end 22 to fill the first 48 and second 50 lateral cavities of the head portion 16. The matrix 54 may further extend through the head portion 16 by way of the transverse apertures 52 to firmly bond to itself and form an integrated composite head (see FIG. 7). In one embodiment, the matrix 54 may similarly extend through one or more apertures 56 near the first end 18 of the handle portion 14 to firmly bond to itself and form an integrated composite handle. In another embodiment, the matrix 54 may cover a portion of the skeleton 12, such as the head portion 16, or the head portion and neck region to the collar 20 or inclusive thereof.

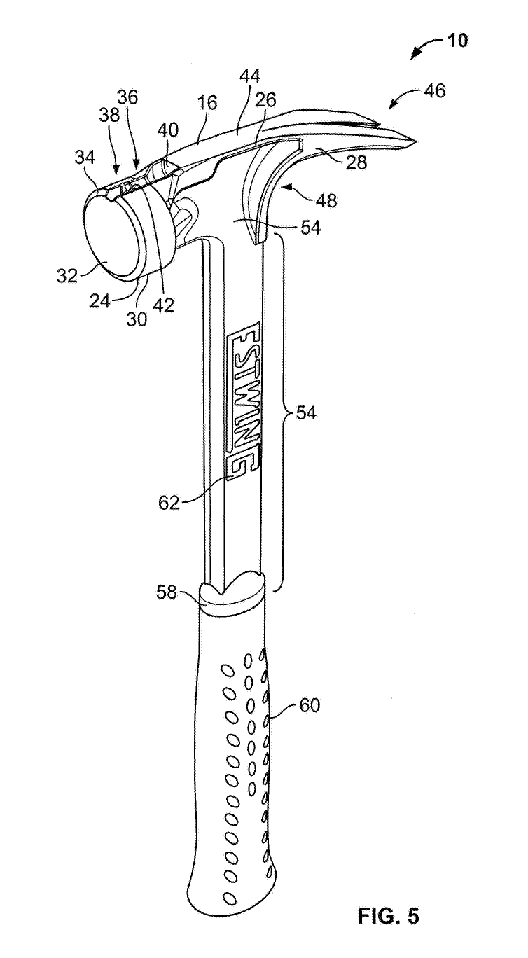

The matrix 54 further may further include surface features, such as a raised collar 58 that aids in the addition of a grip portion 60 over the matrix on the first end 18 of the handle portion 14, as seen in FIG. 5. Additional surface features may be included on the matrix 54, such as indicia 62, which may include instructions, warnings, and the like.

The grip portion 60 may be made of any suitable material or combinations of material, such as leather, plastic, rubber, wood, foam, an elastomeric material, a vibration reducing grip material, and combinations thereof. In one embodiment, the grip material may have a Shore A durometer of from about 40 to about 80, or about 50 to about 75, or about 63 to about 73, or about 60, or about 65, or about 68. Grip materials contemplated for use also include those disclosed in U.S. Pat. No. 6,465,535.

The bonding of the matrix 54 to the skeleton 12 forms a composite striking tool 10 with the matrix and the skeleton each adding strength and durability to the striking tool. Therefore, one important aspect of the present disclosure includes the quality of the bond between the matrix 54 and the skeleton 12 (hereinafter the “matrix bond”). Numerous approaches may be used to ensure a robust matrix bond during the lifetime of the striking tool 10. For example, the matrix 54 may be molded directly to, around, and through the skeleton 12 via apertures 52 (see FIG. 7) and 56 (not shown). In one embodiment, there may be at least 2 apertures, or at least 4 apertures, or at least 6 apertures or more along the skeleton 12 to provide additional anchor points through the skeleton. The apertures may have any shape. In another example, a boundary 64 of the first 48 and second 50 lateral cavities of the head portion 16 may have a negative draft (as shown in FIG. 6) that may aid in further constraining or preventing possible lateral displacement of the matrix 54 from the head portion. While the negative draft of the boundary 64 is shown at the top portion 26 of the head portion 16, the negative draft may be present in any or all of the front 24, top 26, and rear 28 portions of the head portion.

A further approach to increase the strength and durability of the matrix bond is to increase the area of contact between the matrix 54 and the skeleton 12. One method for increasing the surface area of the matrix bond is to add surface features 66a-c to the smooth surface of the skeleton 12 to increase its surface area. For example, three different versions of surface features 66a-c are shown in FIG. 6, which may have a generally pyramidal (66a), square or rectangular (66b), or curved (66c) shapes. Additional shapes are contemplated for the surface features. While the surface features 66a-c may be discrete, raised areas along one, two, three, or four sides of the handle portion 14, it is further envisioned that they may be ring-like or rib-like and surround the handle portion. In addition, additional apertures along the handle portion 14 may provide increased surface area of the matrix bond and permit the matrix 54 to bond to itself through the skeleton 12 at additional points along the skeleton. It is further envisioned in certain embodiments that a striking tool 10 may include multiple apertures 56 along the handle portion 14 in combination with one or more surface features 66a-c.

Another approach that may be employed separately or in addition to those described herein is the use of a primer to coat, clean, or otherwise treat the skeleton 12 before the matrix 54 is applied thereto. Primers may act as adhesion promoting intermediaries between different surfaces to be bonded and may be used in the present context to create a stronger matrix bond. It is further contemplated that the use of a primer may allow for a greater range of material combinations that can be used to construct the composite striking tools 10 of the present disclosure. Primers contemplated in the present disclosure include TECHNOMELT® adhesives available from Henkel Technologies (Madison Heights, Mich.), such as TECHNOMELT PA 2192B. Additional contemplated primers and treatments include those from Lord Chemical Products (Eire, Pa.), such as CHEMLOK® materials. In particular, CHEMLOK® 487 A/B adhesive may be used alone or in conjunction with CHEMLOK® 205 primer. Another example of contemplated primers and treatments include those available from MarChem Corp. (Maryland Heights, Mo.), such as MISTACOTE® F7006-40 Blue Primer.

Additional surface treatments contemplated include surface converting materials, such as BONDERITE M-NT 1455-W, available from Henkel. In addition, along with the use of a primer, surface converting materials, and other surface treatments, or in place thereof, the skeleton may be treated with cleaners to promote stronger matrix bonding. Examples of cleaners include PARCOSOL® 263, available from Henkel.

The skeleton 12 may be formed of multiple pieces or from a single piece of metal or other suitable materials or combinations of materials. Examples of materials that may be used for the skeleton 12 contemplated herein include metals, without limitation, polymers, plastics, composites, wood or other natural material, carbon fiber, graphite, fiberglass, foam, rubber, and combinations thereof. Specific metals contemplated include, among others, titanium, aluminum, steel, and alloys thereof. Further materials contemplated for use herein include polymers and metal alloys and superalloys suitable for additive manufacturing. A material may be selected, for example, based on its hardness, malleability, strength, density, and weight, among other factors.

The skeleton 12 may be formed by casting, fine blanking, plasma cutting, electrochemical machining, electrical discharge machining, metal injection molding, forging, rolling, extruding, milling, molding, die cutting, a computer numeric controlled machining operation, additive manufacturing, such as 3D printing, selective laser sintering, fused deposition modeling, or direct metal laser sintering or any other machining or manufacturing process suitable for a particular material incorporated into the skeleton 12.

The matrix 54 may be made of moldable materials, such as a plastic, a polymer, a metal, a powder, a foam, a fiber-based material, and combinations thereof. Specific examples of contemplated matrix materials include polyurethanes, such as thermoplastic polyurethanes and others, polyamides, plastisols, thermoplastic elastomers, and other thermoplastic or thermoset polymers. Additional contemplated non-moldable matrix materials include carbon fiber, graphite, fiberglass, and the like. Any combination of the moldable and/or non-moldable materials may also be used.

In a further embodiment, the composite striking tool 10 may incorporate additional features, such as a side nail puller or a lumber manipulating feature, such as described in U.S. Pat. No. 5,850,650. Specific types of composite striking tools 10 contemplated herein include, for example, a nail hammer, an axe, a hatchet, a splitting tool, a welding chipping hammer, a drilling hammer, a sledge hammer, a tinner's hammer, an engineer's hammer, a cross peen hammer, a ball peen hammer, a lineman's hammer, a mason's hammer, a drywall hammer, a roofing hammer, a rock pick, an adze, a deadblow hammer, a tack hammer, a soft faced hammer, or any other tool used to strike a surface.

The function of the matrix 54 in the composite striking tools 10 of the present disclosure is to reinforce the skeleton 12 to provide a durable striking tool. Because of the strength added by the matrix 54, the amount of material included in the skeleton 12 can be significantly reduced. The result of the combination of matrix 54 and skeleton 12, therefore, is a strong, durable, and lightweight composite striking tool. To determine the effectiveness of adding the matrix 54 to the skeleton 12, a series of tests were performed, as outlined in the Examples below.

### Examples

To determine the extent to which the matrix 54 contributes to the strength of the composite striking tools 10 of the present disclosure, total deformation and von Mises stress tests were performed on a one-piece steel skeleton alone (made of hardened steel 1055) and a composite hammer having a one-piece steel skeleton (identical to the skeleton-only sample) with a polyurethane matrix bonded thereto. The composite hammer sample did not include a grip. The test samples were constrained in all degrees of freedom over an entire surface extending 4 inches from the end of the sample opposite the head portion (along the first end of the handle where a grip would be added) using a deformable remote displacement constraint.

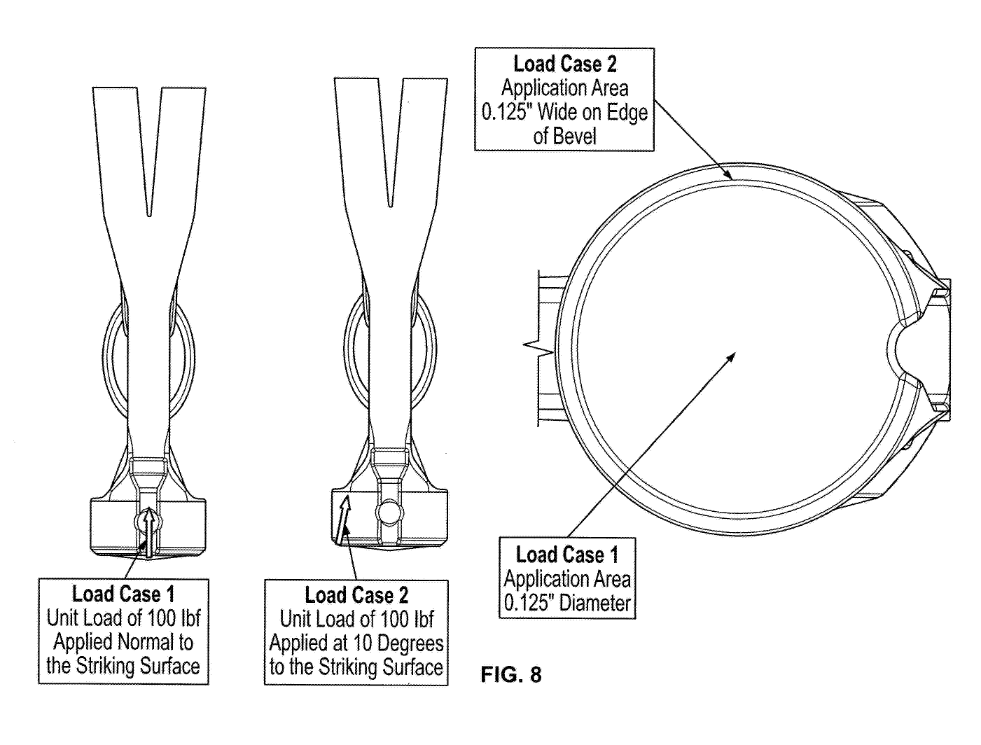

Total deformation and von Mises stress (torsion) values were measured, respectively, using finite element analysis for two separate load cases for each sample: 1) a 100 pound foot (lbf) load was applied normal to the striking face of the head portion at a central point of the striking face; and 2) a 100 lbf load was applied at an angle of 10° from normal to the striking face at a lateral edge thereof. Load application diagrams for each load case are shown in FIG. 8.

Total Deformation and von Mises Stress values and percent differences are provided in Table No. 1 below.

TABLE 1
Total Deformation and von Mises Stress Values

| Total Deformation for 100 lbf Unit | | | von Mises Stress for 100 lbf Unit | | |
|---|---|---|---|---|---|
| Load (inches) | | | Load (psi) | | |
| | Case 1 | Case 2 | | Case 1 | Case 2 |
| Skeleton-only | 0.324 | 1.118 | Skeleton-only | 64,046 | 138,940 |
| Composite | 0.247 | 0.359 | Composite | 49,202 | 55,325 |
| Hammer | | | Hammer | | |
| Percent | 24% | 68% | Percent | 24% | 60% |
| Decrease | | | Decrease | | |

As can be seen in Table No. 1, the composite hammer experienced a 24% decrease in total deformation and a 24% decrease in von Mises stress compared to the skeleton alone for load case 1 (normal load) and a 68% decrease in total deformation and 60% decrease in von Mises stress compared to the skeleton alone for load case 2 (angled load). These results demonstrate that the addition of the matrix 54 to the skeleton 12 greatly reduces not only the stress (total deformation) but also the torsion (von Mises stress) experienced by the skeleton, which demonstrates the importance of the matrix as an integral structural component of the composite hammer 10.

The decreases in total deformation and von Mises stress in the skeleton 12 observed demonstrate the utility and unitary nature of the composite striking tools 10 of the present disclosure. It is further believed that decreases in total deformation and von Mises stress less than those observed may be useful. For example, useful composite striking tools 10 that exhibit an at least about 5%, or about 10%, or about 20% or about 30%, or about 50%, or greater decrease in total deformation and/or an at least about 5%, or about 10%, or about 20% or about 30%, or about 50%, or greater decrease in von Mises stress from forces applied normal or at an angle to the striking surface of the striking tools are contemplated herein.

The contemplated varied decreases in total deformation and von Mises stress may be attributable to varying the characteristics of the matrix 54 itself, for example, by varying the matrix material(s) and/or thicknesses of the matrix. For example, contemplated thicknesses (e.g., depth of matrix material on the skeleton 12 at a given point) of the matrix 54 may be about 0.1, or about 0.2, or about 0.25, or about 0.4, or about 0.5, or about 0.8, or about 1 inch measured at one or more points as the shortest distance from a point on the outer surface of the matrix to a surface of the skeleton 12. In one embodiment, the composite striking tools 10 of the present disclosure may include a matrix 54 of uniform thickness along the skeleton 12.

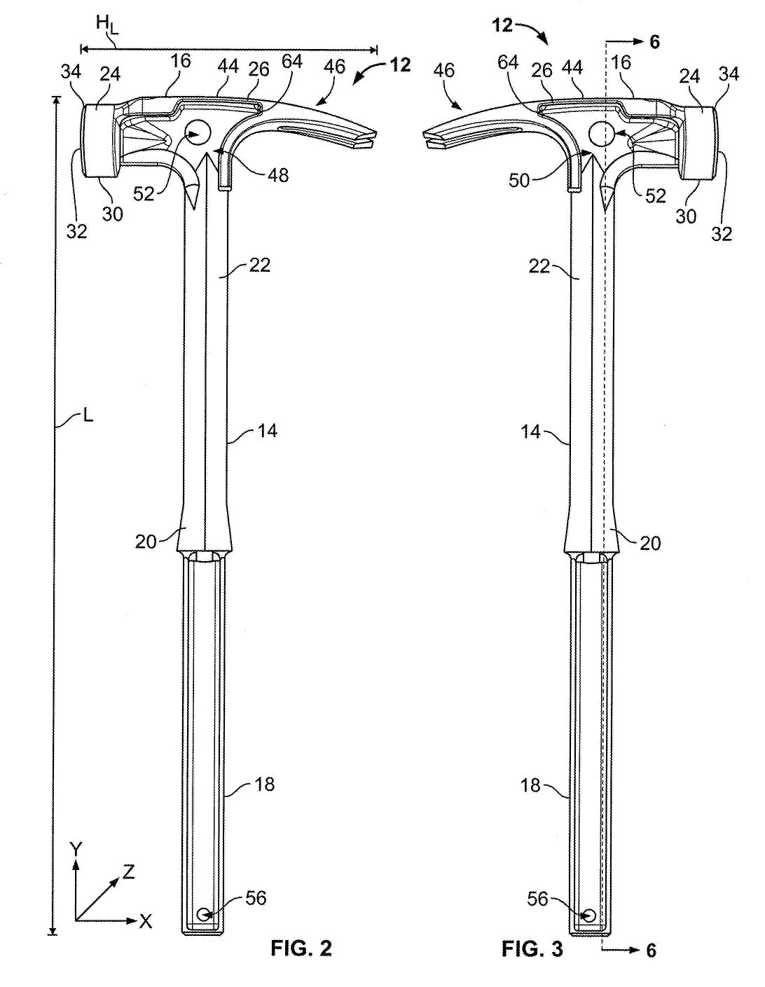

Alternatively, the matrix 54 may have a varied thickness along the skeleton 12. For example, as seen in the embodiment of FIG. 2, the skeleton 12 may have an overall length dimension L of 15.75 inches (parallel to the y-axis) from the first end 18 to the top portion 26 and an overall head portion length H_{L} of 5.5 inches (parallel to the x-axis) from the center of the striking surface 32 to a tip of the claw 46. In this embodiment, the matrix 54 may be over-molded or otherwise added to the skeleton 12 up to a thickness of about 0.375 inches (measured from any side and perpendicular to the overall length L) at a point approximately 3 inches from the bottom of the first end 18. Further, the matrix thickness similarly measured at a point on the skeleton approximately 11 inches from the bottom of the first end 18 may be about 0.080 inches. In addition, the matrix 54 may have a thickness on the head portion 16 of about 0.25 inches (measured along the z axis) at a point approximately 3 inches along the x axis from the striking surface 32.

In one embodiment, the minimal contemplated thickness of the matrix 54 on the skeleton 12 may be about 0.06, or about 0.0625, or about 0.08, or about 0.1, or about 0.325, or about 0.5, or about 0.75 inches, or about 1.0 inch, or may range from about 0.0625 to about 0.75 inches. In a further embodiment, the matrix 54 may have a thickness for the purpose of reducing stress in the skeleton. In another embodiment, the matrix 54 may have a thickness beneath the grip 60 designed to create an ergonomically friendly striking tool 10 for a user that may be tailored to a particular user's hand size.

In one embodiment, the matrix 54 may incorporate one material that provides greater resilience against twisting, for example, in the head and neck region where the striking tool 10 experiences greater twisting moments during use, compared to a second matrix material employed in the handle area of the striking tool. In the handle region, the second matrix material may provide greater shock absorbance. It is further contemplated that the different materials in the matrix 54 may have different appearances, such as color, surface texture, and the like to highlight the presence of the different material and/or denote the different quality of the material employed at a given point on the skeleton 12.

In a further embodiment, the matrix 54 may be comprised of more than one layer. Each separate layer may be composed of the same material and bonded together by an adhesive or by other means. Alternatively, different matrix 54 layers may each vary by material, and/or hardness, modulus of elasticity, thickness, and other parameters, as desired.

In another embodiment, the matrix 54 may cover a smaller subsection of the skeleton 12 and/or there may be windows in the matrix to the skeleton. For example, the matrix 54 may have an open, frame-like appearance with, for example, triangular-, rectangular-, or curvilinear-shaped windows therein revealing the skeleton 12 underneath. As another example, the matrix 54 may have a mesh-like or a woven pattern when applied to the skeleton 12. It is contemplated that a matrix 54 with windows may reduce material costs in terms of matrix materials used while maintaining the overall strength and stress benefit provided to the composite striking tool 10.

In a further embodiment, the matrix 54 may be made of separately formed pieces or portions that are bonded to the skeleton at the same time or in a sequential manner and potentially to each other. In a further embodiment, the matrix 54 may be premade and subsequently bonded to the skeleton 12. In a further embodiment, the matrix 54 may be formed on the skeleton 12.

### INDUSTRIAL APPLICABILITY

The composite striking tools disclosed herein provide improved light weight striking tools with reinforcing over-molded matrix materials with greater durability.

Numerous modifications will be apparent to those skilled in the art in view of the foregoing description. Accordingly, this description is to be construed as illustrative only and is presented for the purpose of enabling those skilled in the art to make and use the invention and to teach the best mode of carrying out same. The exclusive rights to all modifications which come within the scope of the application are reserved. All patents and publications are incorporated by reference. All values and ratios disclosed herein may vary by ±10%, ±20%, or ±40%.

We claim:

1. A striking tool, comprising:
a skeleton comprising:
a handle portion with a first end and a second end, and
a head portion disposed on the second end of the handle portion and comprising a front portion, a top portion, and a rear portion that form first and second lateral cavities; and
a matrix bonded to the skeleton.

2. The striking tool of claim 1, wherein the skeleton is formed of a single piece of at least one of titanium, aluminum, steel, and alloys thereof.

3. The striking tool of claim 1 further comprising a grip disposed on the matrix at the first end of the handle portion.

4. The striking tool of claim 3, wherein the grip comprises leather, plastic, rubber, wood, foam, an elastomeric material, a vibration reducing grip material, or combinations thereof.

5. The striking tool of claim 1, wherein matrix extends through an aperture in the head portion from the first lateral cavity to the second lateral cavity.

6. The striking tool of claim 1, wherein the matrix comprises a window.

7. The striking tool of claim 1, wherein the skeleton comprises a plurality of apertures therethrough.

8. The striking tool of claim 1 further comprising a primer applied to the skeleton.

9. The striking tool of claim 1, wherein the matrix comprises a moldable material.

10. The striking tool of claim 9, wherein the moldable material comprises at least one of a plastic, a polymer, a metal, a powder, a foam, a fiber-based material, or a combination thereof.

11. The striking tool of claim 10, wherein the moldable material comprises a polymer.

12. The striking tool of claim 11, wherein the polymer comprises a polyurethane.

13. The striking tool of claim 1, wherein the skeleton comprises a smooth surface.

14. The striking tool of claim 1, wherein the skeleton comprises a surface feature comprising a raised area along at least one side of the handle portion.

15. The striking tool of claim 1, wherein at least one boundary of the first and second lateral cavities comprises a negative draft adapted to constrain lateral displacement of the matrix from the head portion.

16. A striking tool, comprising:
a skeleton comprising:
a handle portion with a first end and a second end, and
a head portion disposed on the second end of the handle portion and comprising a striking surface; and
a matrix bonded to the skeleton,
wherein the matrix reduces total skeletal deformation of the skeleton from a load applied to the striking surface.

17. The striking tool of claim 16, wherein the matrix reduces total skeletal deformation by at least about 5% from a 100 lbf load applied normal to the striking surface.

18. A composite striking tool, comprising:
a skeleton comprising:
a handle portion with a first end and a second end, and
a head portion disposed on the second end of the handle portion and comprising a striking surface; and
a matrix bonded to the skeleton,
wherein the matrix reduces torsion of the skeleton from a load applied to the striking surface.

19. The striking tool of claim 16, wherein the matrix reduces torsion of the skeleton by at least about 5% from a 100 lbf load applied normal to the striking surface.

20. The composite striking tool of claim 19, wherein the matrix reduces torsion of the skeleton by at least about 5% from a 100 lbf load applied to a side edge of the striking surface at an angle of 10° from normal to the striking surface.
